(19) United States
(12) Patent Application Publication
(10) Pub. No.: US 2006/0209242 A1
(43) Pub. Date: Sep. 21, 2006

(54) Liquid crystal display

(76) Inventors: Ji-Won Sohn, Seoul (KR); Nak-Cho Choi, Seoul (KR); Jae-Jin Lyu, Gwangju-gun (KR)

Correspondence Address: CANTOR COLBURN, LLP, 55 GRIFFIN ROAD SOUTH, BLOOMFIELD, CT, 06002, US

(21) Appl. No.: 11/364,947

(22) Filed: Mar. 1, 2006

(30) Foreign Application Priority Data
Mar. 18, 2005 (KR) 10-2005-0022746

(51) Int. Cl. G02F 1/1343

(52) U.S. Cl. 349/139

(57) ABSTRACT

A liquid crystal display includes: a panel; an electric field generating electrode formed on the panel; and a sloped member formed on the panel. The sloped member has a ridge and a slope, wherein at least one singular portion is formed in the ridge.

This application claims priority to Korean Patent Application No. 2005-0022746, filed on Mar. 18, 2005, and all the benefits accruing therefrom under 35 U.S.C. §119, and the contents of which in its entirety are herein incorporated by reference.

### BACKGROUND OF THE INVENTION

(a) Field of the Invention

The present invention relates to a display panel and a liquid crystal display having the display panel.

(b) Description of the Related Art

A liquid crystal display, which is widely used in flat panel displays, includes two panels (e.g., upper and lower panels) having electric field generating electrodes such as pixel electrodes and a common electrode on respective panels, and a liquid crystal layer interposed therebetween. The liquid crystal display displays an image by applying a voltage to the electric field generating electrodes, which generates an electric field in the liquid crystal layer determining alignment of liquid crystal molecules in the liquid crystal layer to control a polarization of incident light.

Among such liquid crystal displays, a liquid crystal display with a vertical alignment mode has attracted recent attention, since it has a high contrast ratio and easily provides a wide reference viewing angle. A liquid crystal display with a vertical alignment mode arranges major axes of the liquid crystal molecules perpendicular to the upper and lower panels when no electric field is generated.

Current methods of embodying a wide viewing angle in a liquid crystal display with the vertical alignment mode include, forming cut portions in the electric field generating electrodes and forming protrusions on the electric field generating electrodes, for example. Since the direction in which the liquid crystal molecules are tilted can be determined by the use of the cut portions and the protrusions, the reference viewing angle can be widened by variously arranging the cut portions and the protrusions to variously distribute the tilt direction of the liquid crystal molecules.

However, in the method of forming the cut portions, a particular mask is required for patterning a common electrode, and an overcoat layer should be formed on a color filter so as to prevent pigments of the color filter from leaking and contaminating the liquid crystal layer through the cut portions of the common electrode.

In addition, the liquid crystal display with a vertical alignment mode having the protrusions or the cut portions has a slow response speed. The slow response speed is partially due to the cut portions or the protrusions providing strong regulation of the liquid crystal molecules proximate thereto but provide weak regulation of the liquid crystal molecules distal therefrom.

### BRIEF SUMMARY OF THE INVENTION

In exemplary embodiments of the present invention, a liquid crystal display rapidly changes alignment of liquid crystal molecules and minimizes an afterimage due to collisions between the liquid crystal molecules, by minimizing the liquid crystal molecules not affected by a fringe field.

In order to accomplish the above-mentioned aspect, the exemplary embodiments of the present invention include a liquid crystal display including a sloped member for allowing liquid crystal molecules to be tilted in a predetermined direction at a first time, wherein the sloped member has a convex portion or a concave portion.

Specifically, according to an exemplary embodiment of the present invention, a liquid crystal display is provided including a panel, an electric field generating electrode formed on the panel and a sloped member, which is formed on the panel and has a ridge and a slope, wherein at least one singular portion is formed in the ridge. The singular portion may be one of a concave portion and a convex portion, and singular portion may be symmetric about the ridge.

A width of the singular portion extending from the ridge may be in the range of about 10 μm to about 15 μm, and a length thereof may be about 20 μm or less. The singular portion may be disposed at a center of the ridge, and two or more singular portions may be disposed in the ridge. A bottom surface or top surface of the singular portion may be flat or curved (non-planar).

The electric field generating electrode may cover the entire surface of the panel. The tilt angle of the slope of the sloped member may be in the range of about 1° to about 10°, and the slope may be non-linear. The thickness of the sloped member may be in the range of about 0.5 μm to about 2.0 μm.

The liquid crystal display may further include a plurality of color filters formed below the electric field generating electrode, and an overcoat layer may be formed between the electric field generating electrode and the color filters. The sloped member may be disposed between the overcoat layer and the common electrode, and the sloped member may be integrally formed with the overcoat layer.

According to another exemplary embodiment of the present invention, a liquid crystal display is provided including a panel, a first electric field generating electrode formed on the panel, a second electric field generating electrode opposed to the first electric field generating electrode, a liquid crystal layer interposed between the first electric field generating electrode and the second electric field generating electrode and a sloped member, which is formed on the panel and has a ridge and a slope, wherein at least one singular portion is formed in the ridge.

The singular portion may be one of a concave portion and a convex portion, and the singular portion may be symmetric about the ridge. A width of the singular portion extending from the ridge may be in the range of about 10 μm to about 15 μm and a length of the singular portion extending along the ridge may be about 20 μm or less, and a bottom surface or top surface of the singular portion may be flat or curved (non-planar).

The electric field generating electrodes may cover an entire surface of the panel, the tilt angle of the slope of the sloped member may be in the range of about 1° to about 10° and the sloped member may occupy half an area of the electric field generating electrodes.

### BRIEF DESCRIPTION OF THE DRAWINGS

The above and other features and advantages of the present invention will become more apparent by describing in detail exemplary embodiments thereof with reference to the attached drawings, in which:

FIG. 1 is a plan view layout diagram illustrating an exemplary embodiment of a liquid crystal display according to the present invention;

FIG. 2 is a plan view layout diagram illustrating a thin film transistor panel of the liquid crystal display shown in FIG. 1;

FIG. 3 is a plan view layout diagram illustrating a common electrode panel of the liquid crystal display shown in FIG. 1;

FIG. 4 is a cross-sectional view of the liquid crystal display taken along Line IV-IV′-IV″-IV′″ in FIG. 1;

FIGS. 5(a)-5(d) are perspective views illustrating exemplary embodiments of either a concave portion or a convex portion formed in a respective sloped member according to the present invention;

FIG. 6 is a plan view of a plane pattern of the concave and convex portions shown in FIGS. 5(a)-5(d);

FIG. 7 is a plan view layout diagram illustrating another exemplary embodiment of a liquid crystal display according to the present invention;

FIG. 8 is a cross-sectional view of the liquid crystal display taken along Line VIII-VIII′-VIII″-VIII′″ in FIG. 7;

FIG. 9 is a cross-sectional view taken along Line IV-IV′-IV″-IV′″ of FIG. 1 as another example of a cross-sectional view of an alternative exemplary embodiment of the liquid crystal display shown in FIGS. 1 to 3;

FIG. 10 is a cross-sectional view taken along Line IV-IV′-IV″-IV′″ of FIG. 1 as yet another example of a cross-sectional view of yet another alternative exemplary embodiment of the liquid crystal display shown in FIGS. 1 to 3; and

FIG. 11 is a cross-sectional view of another exemplary embodiment of a sloped member according to the present invention.

### DETAILED DESCRIPTION OF THE INVENTION

Hereinafter, exemplary embodiments of the present invention will be described in detail with reference to the attached drawings such that the present invention can be easily put into practice by those skilled in the art. However, the present invention is not limited to the exemplary embodiments, but may be embodied in various forms.

In the drawings, thicknesses are enlarged for the purpose of clearly illustrating layers and areas. If it is mentioned that a layer, a film, an area, or a plate is placed on a different element, it includes a case that the layer, film, area, or plate is placed right on the different element, as well as a case that another element is disposed therebetween. On the contrary, if it is mentioned that one element is placed right on another element, it means that no element is disposed therebetween.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Liquid crystal displays according to exemplary embodiments of the present invention will now be described in detail with reference to the accompanying drawings in which like elements are denoted by like reference numerals throughout the whole specification.

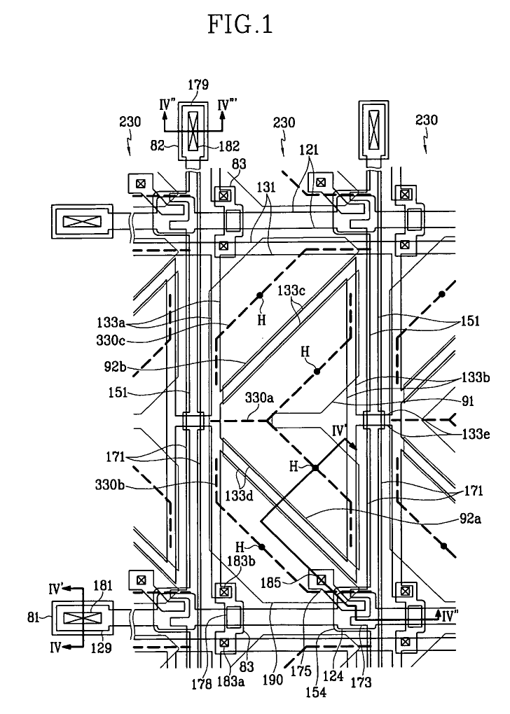

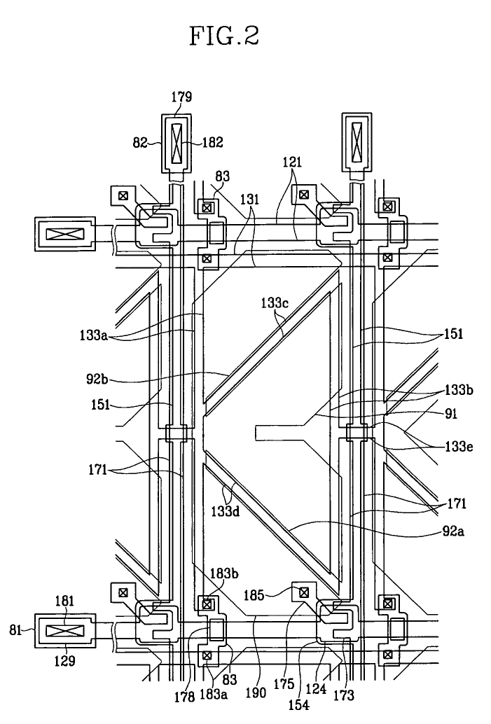

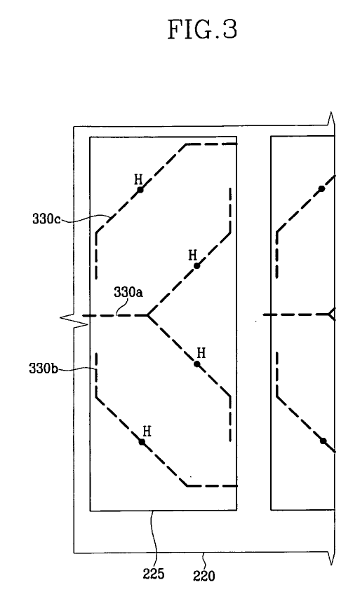

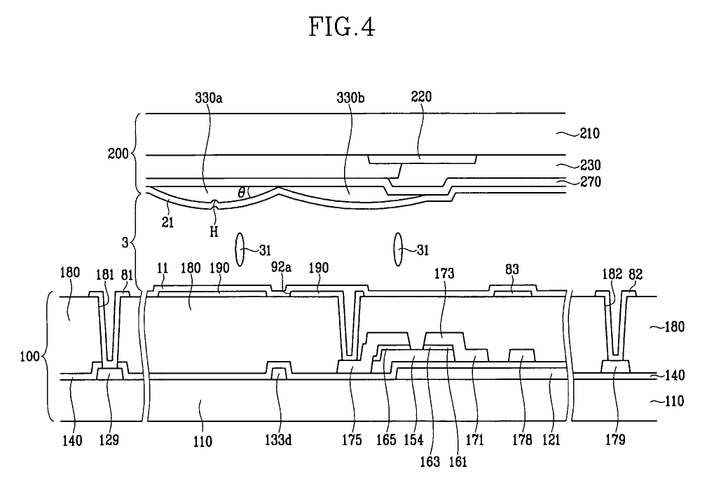

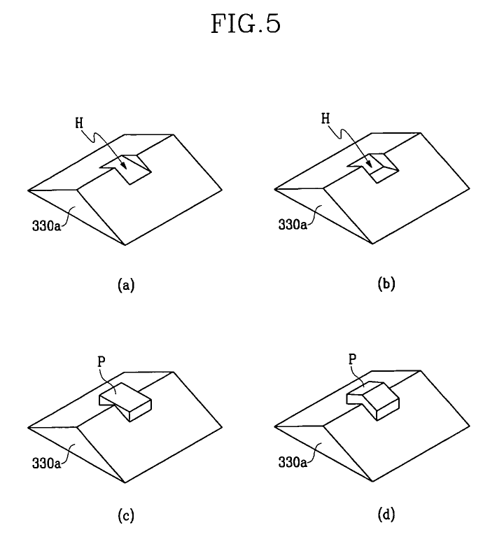

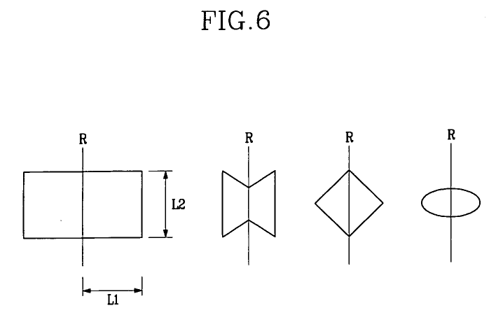

FIG. 1 is a plan view layout diagram illustrating an exemplary embodiment of a liquid crystal display according to the present invention. FIG. 2 is a plan view layout diagram illustrating a thin film transistor panel of the liquid crystal display shown in FIG. 1. FIG. 3 is a plan layout diagram illustrating a common electrode panel of the liquid crystal display shown in FIG. 1. FIG. 4 is a cross-sectional view of the liquid crystal display taken along Line IV-IV′-IV″-IV′″ in FIG. 1. FIG. 5 is a perspective view illustrating concave portions and convex portions formed in an exemplary embodiment of a sloped member according to the present invention. FIG. 6 is a plan view of plane patterns of the concave and convex portions shown in FIG. 5.

The liquid crystal display according to an exemplary embodiment of the present invention includes a thin film transistor panel 100 and a common electrode panel 200 opposed to each other, and a liquid crystal layer 3 interposed between the panels 100 and 200.

The thin film transistor panel 100 is described first in detail with reference to FIGS. 1, 2 and 4. A plurality of gate lines 121 and a plurality of storage electrode lines 131 are formed on an insulating panel 110.

The gate lines 121 serve to supply gate signals and mainly extend horizontally and are separated from each other, as illustrated in FIGS. 1 and 2. Each gate line 121 has a large-area end portion 129 for connecting a plurality of gate electrodes 124, which protrude upwardly and downwardly, to other layers or driver circuits (not shown). When the driver circuits are integrated on the thin film transistor panel 100, the gate lines 121 can extend to the driver circuits for connection therewith.

Each storage electrode line 131 mainly extends horizontally and is disposed between two neighboring gate lines 121 so as to be closer to the upper gate line 121 of the two gate lines 121, as illustrated in FIGS. 1 and 2. Each storage electrode line 131 includes a plurality of sets of branches 133a to 133d and a plurality of connections 133e.

Each set of branches includes first and second storage electrodes 133a and 133b, respectively, extending vertically and separated from each other, and third and fourth storage electrodes 133c and 133d, respectively, extending obliquely relative to third and fourth storage electrodes 133c and 133d to connect the first storage electrode 133a to the second storage electrode 133b, as illustrated in FIGS. 1 and 2.

The first storage electrode 133a has a fixed end connected to the storage electrode line 131 and a free end having a protruded portion.

The third and fourth storage electrodes 133c and 133d are connected to both ends of the second storage electrode 133b in the vicinity of the center thereof. The third and fourth storage electrodes 133c and 133d are inversely symmetrical about the center line between the two neighboring gate lines 121. The plurality of connections 133e connect the first storage electrode 133a and the second storage electrode 133b adjacent to each other in the neighboring sets of storage electrodes 133a to 133d.

The storage electrode lines 131 are supplied with a predetermined voltage such as a common voltage, which is supplied to a common electrode 270 of the common electrode panel 200. Each storage electrode line 131 is defined by a pair of stem lines extending horizontally, as illustrated in FIGS. 1 and 2.

It is preferable that the gate lines 121 and the storage electrode lines 131 are made of a silver group metal such as silver (Ag) or a silver alloy, an aluminum group metal such as aluminum (Al) or an aluminum alloy, a copper group metal such as copper (Cu) or a copper alloy, a molybdenum group metal such as molybdenum (Mo) or a molybdenum alloy, chromium, titanium, or tantalum. Alternatively, the gate lines 121 and the storage electrode lines 131 may have a multi-layered structure including two conductive layers (not shown), each conductive layer having different physical properties. One conductive layer thereof may be made of a metal having low resistance such as an aluminum group metal, a silver group metal and a copper group metal so as to reduce delay of signals or voltage drop. The other conductive layer may be made of a metal having excellent physical, chemical and electrical contact characteristic with ITO (Indium Tin Oxide) or IZO (Indium Zinc Oxide), such as a molybdenum group metal, chromium (Cr), titanium (Ti), and tantalum (Ta). An example of such a combination includes a combination of a chromium lower layer and an aluminum (alloy) upper layer and a combination of an aluminum (alloy) lower layer and a molybdenum (alloy) upper layer. Otherwise, the gate lines 121 and the storage electrode lines 131 may be made of various other metals and conductive materials.

The side surfaces of the gate lines 121 and the storage electrode lines 131 are sloped with respect to the surface of the panel 110. The side surfaces of the gate lines 121 and the storage electrode lines 131 have a slope angle in the range of about 30° to about 80°.

A gate insulating layer 140 made of silicon nitride (SiNₓ), or the like, is formed on the gate lines 121 and the storage electrode lines 131.

A plurality of line-shaped semiconductor patterns 151 (FIGS. 1 and 2) made of hydrogenated amorphous silicon (where amorphous silicon can be abbreviated as a-Si) or polysilicon are formed on the gate insulating layer 140. Each line-shaped semiconductor pattern 151 mainly extends vertically and includes a plurality of extensions 154 extending toward the gate electrodes 124, as illustrated in FIGS. 1 and 2.

The line-shaped semiconductor patterns 151 are widened in a vicinity of the gate lines 121 and the storage electrode lines 131, so as to substantially cover them.

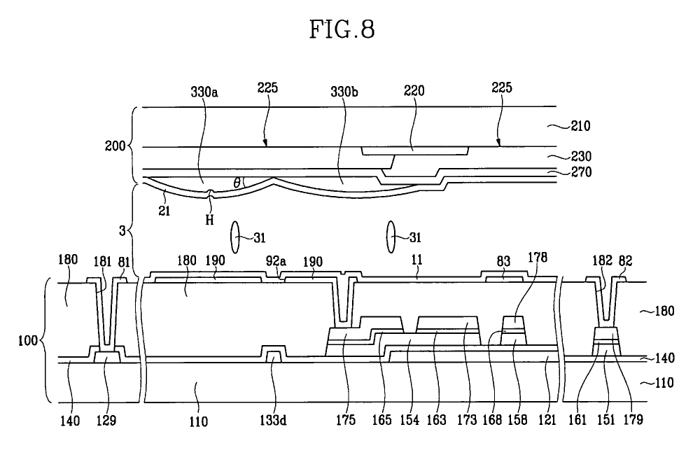

A plurality of line-shaped and island-shaped ohmic contact members 161 (see FIG. 8) and 165, respectively, made of silicide or a material such as n+ hydrogenated amorphous silicon which is doped with n-type impurities such as phosphorous at a high concentration are formed on the semiconductor patterns 151. The line-shaped ohmic contact member 161 has a plurality of extensions 163. The extensions 163 and the island-shaped ohmic contact members 165, which form pairs, are formed on the extensions 154 of the semiconductor patterns 151.

The side surfaces of the semiconductor patterns 151 and the ohmic contact members 161 and 165 are also sloped with respect to the surface of the panel 110. The slope angle of the side surfaces is preferably in the range of about 30° to about 80°.

A plurality of data lines 171, a plurality of drain electrodes 175 and a plurality of isolated metal pieces 178 are formed on the ohmic contact members 161 and 165 and the gate insulating layer 140.

The data lines 171 extend mainly in the vertical direction, intersect the gate lines 121 to define substantially a right angle and serve to deliver the data voltages. The data lines 171 also intersect the storage electrode lines 131 and the connections 133e, as illustrated in FIGS. 1 and 2. The data lines 171 are disposed between the first storage electrode 133a and the second storage electrode 133b adjacent to each other in the neighboring branch sets 133a to 133d of the storage electrode lines 131. Each data line 171 includes a plurality of source electrodes 173 extending toward the respective gate electrodes 124, and a large-area end portion 179 for connection to another layer or an external device. When a data driving circuit (not shown) for generating data voltages is integrated on the panel 110, the data lines 171 can extend to the driving circuit, so as to be connected directly to the data driving circuit.

Each drain electrode 175 includes a large-area end portion for connection to another layer and a bar-shaped end portion positioned on the gate electrodes 124. The source electrodes 173 are curved (e.g., inverted C-shape) to surround a part of the bar-shaped end portions, as illustrated in FIGS. 1 and 2.

One gate electrode 124, one source electrode 173 and one drain electrode 175 constitute one thin film transistor (“TFT”) together with the extension 154 of the semiconductor pattern 151. The channel of the thin film transistor is formed in the extension 154 between the source electrode 173 and the drain electrode 175.

The metal pieces 178 are disposed on the gate lines 121 in the vicinity of the end portions of the storage electrodes 133a.

The data lines 171, the drain electrodes 175 and the metal pieces 178 preferably include a refractory metal such as a molybdenum group metal, chromium, tantalum, and titanium, or alloys thereof, and may have a multi-layered structure including a first conductive layer (not shown) made of a refractory metal and a second conductive layer (not shown) having low resistance. Examples of the multi-layered structure can include a double-layered film including a chromium or molybdenum (alloy) lower layer and an aluminum (alloy) upper layer, and a triple-layered film including a molybdenum (alloy) lower layer, an aluminum (alloy) intermediate layer, and a molybdenum (alloy) upper layer. Otherwise, the multi-layered structure may be made of a variety of other metals and conductive materials.

Similarly to the gate lines 121 and the storage electrode lines 131, the side surfaces of the data lines 171 and the drain electrodes 175 are sloped with respect to the surface of the panel 110. The slope angle of the side surfaces of the gate lines 121 and the storage electrode lines 131 is in the range of about 30° to about 80°.

The ohmic contact members 163 and 165 exist only between the semiconductor patterns 151 at the lower side and between the data lines 171 at the upper side and serve to decrease the ohmic resistance. The line-shaped semiconductor patterns 151 have portions exposed between the source electrodes 173 and the drain electrodes 175 and on the data lines 171 and the drain electrodes 175. The width of the line-shaped semiconductor patterns 151 is smaller than the width of the data lines 171 at most places, but as described above, the width becomes greater where the gate lines 121 and the storage electrode lines 131 intersect each other to smooth the profile of the surface, thereby preventing a short circuit of the data lines 171.

A passivation layer 180 is formed on the data lines 171, the drain electrodes 175, and the metal pieces 178 and on the portions of the semiconductor patterns 151 not covered with the data lines 171, the drain electrodes 175 and the metal pieces 178. The passivation layer 180 is made of an inorganic insulating material such as silicon nitride and silicon oxide, an organic insulating material, or an insulating material having a low dielectric constant. It is preferable that the dielectric constant of the insulating material has a dielectric constant of 4.0 or less. Examples of a suitable insulating material for passivation layer 180 include a-Si:C:O and a-Si:O:F formed by the use of a plasma enhanced chemical vapor deposition (“PECVD”) method. The passivation layer 180 may be made of an organic insulating material having photosensitivity, and the surface of the passivation layer 180 may be flat. Alternatively, the passivation layer 180 may have a double-layered structure including a lower inorganic layer and an upper organic layer so as to secure an excellent insulating characteristic of the organic layer and protect the exposed portions of the semiconductor patterns 151 with the inorganic layer.

A plurality of contact holes 182 and 185 are formed in the passivation layer 180. The plurality of contact holes 182 and 185 expose the end portions of the data lines 171 and the large-area end portions of the drain electrodes 175. A plurality of contact holes 181 are formed in the passivation layer 180 and the gate insulating layer 140. The plurality of contact holes 181 expose the end portions 129 of the gate lines 121, a plurality of contact holes 183a for exposing a part of the storage electrode lines 131 in the vicinity of the fixed ends of the first storage electrodes 133a and a plurality of contact holes 183b for exposing the extensions of the free ends of the first storage electrodes 133a.

A plurality of pixel electrodes 190, a plurality of contact assistants 81 and 82, and a plurality of overpasses 83 are formed on the passivation layer 180. The plurality of pixel electrodes 190, a plurality of contact assistants 81 and 82, and a plurality of overpasses 83 may be made of at least one of a transparent conductive material, such as ITO and IZO, or a metal having excellent reflectivity, such as aluminum or a silver alloy. The pixel electrodes 190 are physically and electrically connected to the drain electrodes 175 through the contact holes 185, and are supplied with the data voltages from the drain electrodes 175. The pixel electrodes 190 supplied with the data voltages generate an electric field together with the common electrode 270, thereby determining the alignment of liquid crystal molecules 31 of the liquid crystal layer 3.

The pixel electrodes 190 and the common electrode 270 constitute a capacitor (hereinafter, referred to as “liquid crystal capacitor”) that holds the applied voltage after the thin film transistors are turned off. In order to reinforce the voltage holding ability, other capacitors, which are referred to as storage capacitors, are connected in parallel to the liquid crystal capacitors. The storage capacitors are formed by overlapping the pixel electrodes 190 with the storage electrode lines 131.

Each pixel electrode 190 is chamfered at the left corners, and the chamfered oblique sides form an angle of about 45° with respect to the gate lines 121, as illustrated in FIGS. 1 and 2.

A central cut portion 91, a lower cut portion 92a and an upper cut portion 92b are formed in each pixel electrode 190. Each pixel electrode 190 is divided into a plurality of partitions by the cut portions 91, 92a, and 92b. The cut portions 91, 92a, and 92b form inversion symmetry about a virtual horizontal center line (e.g., see dashed line indicated with reference numeral 330a in FIG. 1) dividing the pixel electrode 190 into two halves.

The lower and upper cut portions 92a and 92b extend obliquely from the right edge of the pixel electrode to the left edge and overlap with the third and fourth storage electrodes 133c and 133d. The lower and upper cut portions 92a and 92b are disposed in the lower half and the upper half, respectively, with respect to the horizontal center line of the pixel electrode 190. The lower and upper cut portions 92a and 92b extend perpendicular to each other to form an angle of about 45° with respect to the gate lines 121.

The central cut portion 91 extends along the horizontal center line of the pixel electrode 190 and has an opening at the right edge, as illustrated in FIGS. 1 and 2. The opening of the central cut portion 91 has a pair of oblique sides that are substantially parallel to the lower cut portion 92a and the upper cut portion 92b, respectively.

Therefore, the lower half of the pixel electrode 190 is divided into two partitions by the lower cut portion 92a, and the upper half of the pixel electrode 190 is divided into two partitions by the upper cut portion 92b. Here, the number of partitions or the number of cut portions can vary depending upon design factors such as the size of the pixel, the aspect ratio of the pixel electrode and the kind or characteristics of the liquid crystal layer 3.

The contact assistants 81 and 82 are connected to the end portions 129 of the gate lines 121 and the end portions 179 of the data lines 171 through the contact holes 181 and 182, respectively. The contact assistants 81 and 82 reinforce the adhesion between the end portions 179 and 129 of the data lines 171 and the gate lines 121 and an external device, and protect the data lines 171 and the gate lines 121 and an external device.

The overpasses 83 cross the gate lines 121 and are connected to the exposed end portions of the free ends of the first storage electrodes 133a and the exposed portions of the storage electrode lines 131 through the contact holes 183a and 183b positioned on both sides of the gate lines 121, as illustrated in FIGS. 1 and 2. The overpasses 83 overlap with the metal pieces 178 and may be electrically connected to the metal pieces 178. The storage electrode lines 131 including the storage electrodes 133a to 133d can be used together with the overpasses 83 and the metal pieces 178 to repair defects of the gate lines 121, the data lines 171 or the thin film transistors. When repairing the gate lines 121, the gate lines 121 and the storage electrode lines 131 are electrically connected to each other by irradiating a laser beam at intersections between the gate lines 121 and the overpasses 83 to connect the gate lines 121 to the overpasses 83. At this time, the metal pieces 178 serve to reinforce the electrical connection between the gate lines 121 and the overpasses 83.

The common electrode panel 200 will now be described with reference to FIGS. 1, 3, and 4.

A light blocking member 220 referred to as a black matrix is formed on an insulating panel 210 made of transparent glass or the like. The light blocking member 220 has a plurality of openings which are opposed to the pixel electrodes 190 and have substantially the same shape as the pixel electrodes 190. The light blocking member 220 may include only linear portions extending along the data lines 171, and may further include portions opposed to the thin film transistors in addition thereto. The light blocking member 220 may be formed of a single-layered film of chromium, a double-layered film of chromium and chromium oxide or an organic layer including a black pigment.

A plurality of color filters 230 are formed on the panel 210. Most of the color filters 230 are disposed in the openings of the light blocking member 220. The color filters 230 may extend in the vertical direction along the pixel electrodes 190, as illustrated in FIG. 1. Each color filter 230 can display one of three colors such red, green, and blue, and may also be primary colors. The edges of the neighboring color filters 230 may overlap with each other.

The common electrode 270 is formed on the color filters 230 and may be made of a transparent conductive material such as ITO or IZO.

An overcoat layer (not shown) for preventing the color filters 230 from being exposed and providing a flat plane may be formed between the common electrode 270 and the color filters 230.

A plurality of sets of sloped members 330a, 330b and 330c are formed on the common electrode 270. It is preferable that the sloped members 330a to 330c are made of a dielectric material and that the dielectric constant thereof is less than or equal to the dielectric constant of the liquid crystal layer 3.

Each set of sloped members includes three sloped members 330a to 330c opposed to the pixel electrode 190. Each sloped member 330a to 330c has a ridge and slopes spreading out from the ridge. Each of the ridges comprises one or two primary ridges and two or three secondary ridges, which are connected to ends of the primary ridges. The primary ridges are substantially parallel to the oblique sides of the cut portions 91, 92a and 92b and the oblique side of the corresponding pixel electrode 190, and is opposed to the oblique side of the cut portions 91, 92a and 92b or the corresponding pixel electrode 190. The secondary ridges are parallel to the corresponding gate line 121 or the corresponding data line 171.

The ridges are represented by thick dotted lines in FIGS. 1 and 3. The ridge is disposed between the cut portions 91, 92a and 92b or between the cut portions 92a and 92b and the oblique side of the corresponding pixel electrode 190, and extends parallel to the cut portions 91, 92a and 92b.

The slope is a plane from the ridge to the periphery, and the plane gradually decreases in height. It is preferable that the height of the ridge is in the range of about 0.5 to 2.0 μm, and that the slope angle θ of the slope is in the range of about 1° to about 10°.

It is preferable that the area of one set of sloped members 330a to 330c is greater than a half of the area of the corresponding pixel electrode 190. The sloped members 330a to 330c for the neighboring pixel electrodes 190 may be connected to each other.

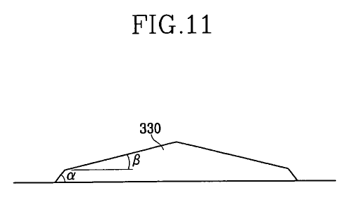

The slopes of the sloped members 330a to 330c may be bent once or include a different slope angle in the intermediate portion, as shown in FIG. 11. In this case, it is preferable that a first slope angle at the portion closer to the bottom is less than or equal to α=60°, and that a second slope angle at the portion closer to the ridge is less than or equal to β=10°. FIG. 11 is a cross-sectional view of a sloped member according to another exemplary embodiment of the present invention.

Referring again to FIGS. 1 and 3, including FIG. 5, a concave portion H is formed at the center of the ridge of the sloped members 330a to 330c. The concave portion H can be replaced with various shapes of concave portions H or a convex portion P as shown in FIG. 5. Two or more concave portions H or two or more convex portions P may be formed in each ridge.

As shown in FIG. 5, the bottom surface of the concave portion H may be (a) flat or (b) non-planar, and the top surface of the convex portion P may be (c) flat or (c) non-planar. As shown in FIG. 6, the shape of the singular portions H and P in a top plan view may be circular, elliptical, or polygonal, which are substantially symmetric about the ridge R. It is preferable that the width L1 of the singular portions H and P from the ridge is in the range of about 10 μm to about 15 μm and that the length L2 of the singular portions H and P along the ridge is about 10 μm or less. The shape and size of the singular portion H and P are not limited to the above-mentioned shapes and sizes, but may be of various other sizes and shapes.

Such a concave portion H or convex portion P can be formed by applying an organic material and then performing a photolithography process or a photolithographic etching process using a mask. In this case, by forming slits or translucent films for controlling the amount of exposure of light in the mask, different amounts of light exposure are used for the concave portion or the convex portion and the slope of the sloped member.

Alignment layers 11 and 21 are formed on the inner surfaces of the panels 100 and 200 described above (FIG. 4), and they may be vertical alignment layers. Polarizing films (not shown) are provided on the outer surfaces of the panels 100 and 200. The transmission axes of the polarizing films are perpendicular to each other, in which one transmission axis is parallel to the gate lines 121. In a reflective liquid crystal display, one polarizing film may be omitted.

At least one retardation film (not shown) for compensating for the delay of the liquid crystal layer 3 may be interposed between the panels 100 and 200 and the polarizing films. The retardation film has birefringence and serves to reversely compensate for the birefringence of the liquid crystal layer 3. A mono-axial optical film or a biaxial optical film can be used as the retardation film, and a negative mono-axial optical film may be preferably employed.

A spacer member (not shown), which is made of an insulating material and maintains a gap between the two panels 100 and 200, is formed between the thin film transistor panel 100 and the common electrode panel 200. The spacer may be formed with the same material as the sloped members 330a, 330b, and 330c. The spacer may be formed along with the sloped members 330a, 330b, and 330c through a photolithography process.

The liquid crystal display may include the polarizing film, the retardation film, the two panels 100 and 200 and a backlight unit for supplying light to the liquid crystal layer 3.

The liquid crystal layer 3 has negative dielectric anisotropy, and the liquid crystal molecules 31 of the liquid crystal layer 3 are aligned such that the major axis thereof is substantially perpendicular to the surfaces of the two panels without any electric field being applied thereto. Therefore, incident light does not pass through the orthogonal polarizing films and is blocked in the absence of any electric field.

When a common voltage is applied to the common electrode 270 and the data voltages are applied to the pixel electrodes 190, an electric field is generated substantially perpendicular to the surfaces of the panels 100 and 200. The liquid crystal molecules 31 change their alignment in response to the electric field such that the major axes thereof are perpendicular to the electric field. At this time, the sloped members 330a to 330c, the cut portions 91, 92a, 92b of the pixel electrodes 190 and the edges of the pixel electrodes 190 determine the tilt direction of the liquid crystal molecules 31, which will be described below in detail.

The liquid crystal molecules 31 are pre-tilted by the sloped members 330a to 330b when there is no electric field. When the liquid crystal molecules 31 are pre-tilted, the liquid crystal molecules 31 are tilted in the pre-tilted direction when an electric field is applied, and the tilt direction is perpendicular to the edges of the cut portions 91, 92a, and 92b and the edges of the pixel electrodes 190.

On the other hand, the cut portions 91, 92a, and 92b of the pixel electrodes 190 and the edges of the pixel electrodes 190 parallel to the cut portions 91, 92a, and 92b distort the electric field to generate a horizontal component, which determines the tilt direction. The horizontal component of the electric field is perpendicular to the edges of the cut portions 91, 92a, and 92b and the edges of the pixel electrodes 190.

The equipotential surface of the electric field varies due to the difference in thickness of the sloped members 330a to 330b, thereby applying the tilting force to the liquid crystal molecules 31. The tilting force coincides with the tilt direction determined by the cut portions 91, 92a, and 92b and the sloped members 330a to 330c. The tilting force is more substantial when the dielectric constant of the sloped members 330a to 330c is smaller than that of the liquid crystal layer 3.

Therefore, the tilt direction of the liquid crystal molecules 31 apart from the cut portions 91, 92a, and 92b and the oblique sides of the pixel electrodes 190 is determined, thereby enhancing the response speed of the liquid crystal molecules 31.

On the other hand, as shown in FIG. 1, one set of cut portion members 91, 92a, and 92b and one set of sloped members 330a to 330c divide one pixel electrode 190 into a plurality of sub-areas of which each sub-area has two primary ridges. The liquid crystal molecules 31 of each sub-area are tilted in the tilt direction as described above, and the tilt direction includes approximately four directions. In this way, by varying the tilt directions of the liquid crystal molecules, the reference viewing angle of the liquid crystal display can be enhanced.

On the other hand, the singular portions H and P of the sloped members 330a to 330b arrange the liquid crystal molecules 31 in the vicinity of the ridges of the sloped members 330a to 330c to correspond to the shapes of the singular portions H and P, thereby preventing the tilt direction of the liquid crystal molecules 31 in the vicinity of the ridges from being disturbed. When the singular portions H and P are not provided, the pre-tilt is not established in the vicinity of the ridges of the sloped members 330a to 330c, and the two horizontal components of the electric field generated with both cut portions have the same magnitude and opposite directions. Accordingly, the two horizontal components are cancelled. Therefore, when the singular portions H and P are not provided, the liquid crystal molecules 31 in the vicinity of the ridges cannot easily determine the tilt direction, or the tilt directions vary frequently, thereby slowing the total response time of the liquid crystal molecules 31.

In this way, the cut portions may not be provided in the common electrode 270, since the tilt direction of the liquid crystal molecules 31 can be determined by the use of only the cut portions 91, 92a, and 92b of the pixel electrodes and the sloped members 330a to 330c. Accordingly, a process of patterning the common electrode 270 can be omitted. Since electric charges are not accumulated at specific positions by omitting the cut portions from the common electrode 270, it is possible to prevent the electric charges from moving to and damaging a polarizing film (not shown). Accordingly, an electrostatic discharge preventing process for preventing damage to the polarizing film can be omitted. Therefore, omitting the cut portions can remarkably reduce the cost for manufacturing the liquid crystal display.

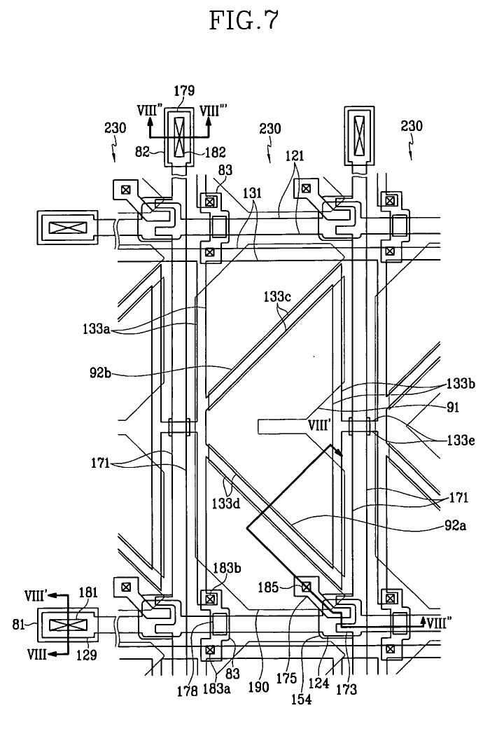

Next, a liquid crystal display according to another exemplary embodiment of the present invention will be described in detail with respect to FIGS. 7 and 8.

FIG. 7 is a plan view layout diagram illustrating a liquid crystal display according to another exemplary embodiment of the present invention FIG. 8 is a cross-sectional view of the liquid crystal display taken along Line VIII-VIII′-VIII″-VIII′″ in FIG. 7.

As shown in FIGS. 7 and 8, the liquid crystal display according to the present exemplary embodiment includes a thin film transistor panel 100 and a common electrode panel 200 opposed to each other, and a liquid crystal layer 3 interposed therebetween.

The layered structures of the panels 100 and 200 according to the present embodiment are similar to those of the liquid crystal display shown in FIGS. 1 to 4.

The layered structure of the thin film transistor panel 100 is described first. A plurality of gate lines 121 having gate electrodes 124 and end portions 129 and a plurality of storage electrode lines 131 having storage electrodes 133a to 133d, are each formed on a panel 110. A gate insulating layer 140, a plurality of line-shaped semiconductor patterns 151 including extensions 154, and a plurality of line-shaped ohmic contact members 161 having extensions 163 and a plurality of island-shaped ohmic contact members 165 are sequentially formed on the panel 110. A plurality of data lines 171 including source electrodes 173 and end portions 179, a plurality of drain electrodes 175, and a plurality of isolated metal pieces 178 are formed on the ohmic contact members 161 and 165, and a passivation layer 180 is formed thereon. A plurality of contact holes 181, 182, 183a, 183b and 185 are formed in the passivation layer 180 and the gate insulating layer 140, and a plurality of pixel electrodes 190 having cut portions 91, 92a, and 92b, a plurality of contact assistants 81 and 82 and a plurality of overpasses 83 are formed thereon.

The layered structure of the common electrode panel 200 is now described. A light blocking member 220 having a plurality of openings 225, a plurality of color filters 230, a common electrode 270 and an alignment layer 21 are formed on an insulating panel 210.

Unlike the liquid crystal display shown in FIGS. 1 to 4, in the liquid crystal display according to the present exemplary embodiment, the line-shaped semiconductor patterns 151 have substantially the same top shapes as the data lines 171, the drain electrodes 175 and the ohmic contact members 161 and 165. However, the extensions 154 of the line-shaped semiconductor patterns 151 have portions not covered with the data lines 171 and the drain electrodes 175 between the source electrodes 173 and the drain electrodes 175.

The thin film transistor panel 100 according to the present exemplary embodiment includes a plurality of island-shaped semiconductor patterns 158 which are disposed below the metal pieces 178 and have substantially the same top shape as the metal pieces 178 and a plurality of ohmic contact members 168 disposed thereon.

In manufacturing the thin film transistor according to an exemplary embodiment of the present invention, the data lines 171, the drain electrodes 175, the metal pieces 178, the semiconductor patterns 151 and the ohmic contact members 161 and 165 are formed through the same photolithography process.

A photoresist film used in the photolithography process has different thicknesses by position and includes first portions and second portions. The first portions have a thickness larger than that of the second portions. The first portions are positioned in a wiring area occupied by the data lines, the drain electrodes and the metal pieces 178. The second portions are positioned in channel regions of the thin film transistors.

An example of the method of changing the thickness of the photoresist film includes a method of providing a translucent area in addition to a light transmitting area and a light blocking area. The translucent area is provided with a slit pattern, a lattice pattern or a thin film having middle transmissivity or a middle thickness. When the slit pattern is used, it is preferable that the width of the slits or the gap between the slits is smaller than the resolution of an exposing apparatus used in the photolithography process. As another example of changing the thickness of the photoresist film, a method employing a photoresist film which can reflow is known. That is, the photoresist film which can reflow is formed by the use of a general exposure mask having only the light transmitting area and the light blocking area. The photoresist film is allowed to reflow into the area where the photoresist film does not remain, thereby forming the thin portions.

In this way, the manufacturing method is simplified, as the photolithography process can be reduced by one step.

It will be recognized by those skilled in the pertinent art that many features of the liquid crystal display shown in FIGS. 1 to 4 can apply to the liquid crystal display shown in FIGS. 7 and 8.

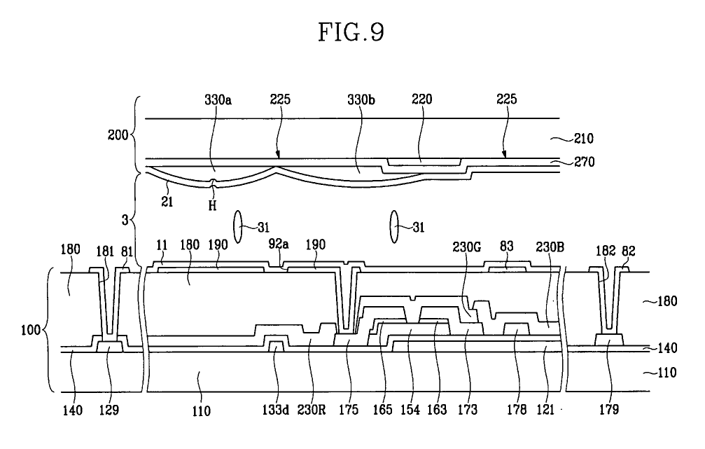

FIG. 9 is a cross-sectional view taken along Line IV-IV′-IV″-IV′″ of FIG. 1 as another example of a cross-sectional view of an alternative exemplary embodiment of the liquid crystal display shown in FIGS. 1 to 3 in accordance with the present invention.

As shown in FIG. 9, the liquid crystal display according to the present exemplary embodiment includes a thin film transistor panel 100 and a common electrode panel 200 opposed to each other, and a liquid crystal layer 3 interposed therebetween.

The layered structures of the panels 100 and 200 according to the present embodiment are similar to those of the liquid crystal display shown in FIGS. 1 to 4.

The layered structure of the thin film transistor panel 100 is described first. A plurality of gate lines 121 having gate electrodes 124 and end portions 129 and a plurality of storage electrode lines 131 having storage electrodes 133a to 133d are formed on a panel 110. A gate insulating layer 140, a plurality of line-shaped semiconductor patterns 151 including extensions 154, and a plurality of line-shaped ohmic contact members 161 having extensions 163 and a plurality of island-shaped ohmic contact members 165 are sequentially formed on the panel 110.

A plurality of data lines 171 including source electrodes 173 and end portions 179, a plurality of drain electrodes 175, and a plurality of isolated metal pieces 178 are formed on the ohmic contact members 161 and 165, and a passivation layer 180 is formed thereon. A plurality of contact holes 181, 182, 183a, 183b, and 185 are formed in the passivation layer 180 and the gate insulating layer 140, and a plurality of pixel electrodes 190 having cut portions 91, 92a, and 92b, a plurality of contact assistants 81 and 82, and a plurality of overpasses 83 are formed thereon.

The layered structure of the common electrode panel 200 is now described. A light blocking member 220 having a plurality of openings 225, a common electrode 270, a plurality of sloped members 330a and 330b and an alignment layer 21 are formed on an insulating panel 210.

Unlike the liquid crystal display shown in FIGS. 1 to 4, in the liquid crystal display according to the present exemplary embodiment, no color filter is formed on the common electrode panel 200, but a plurality of color filters 230R, 230G and 230B are formed under the passivation layer 180 of the thin film transistor panel 100. The color filters 230R, 230G and 230B extend vertically along the columns of the pixel electrodes 190, and the neighboring color filters 230R, 230G and 230B overlap with each other on the data lines 171. Here, the color filters 230R, 230G and 230B of red, green and blue, respectively, function as light blocking members for blocking light that leaks between the neighboring pixel electrodes 190. Accordingly, the light blocking member 220 is omitted from the common electrode panel 200, thereby simplifying the processes.

An interlayer insulating layer (not shown) may be disposed under the color filters 230.

In the liquid crystal display shown in FIGS. 7 and 8, the color filters 230 may be disposed under the passivation layer 180.

It will be recognized by those skilled in the pertinent art that many features of the liquid crystal display shown in FIGS. 1 to 4 can apply to the liquid crystal display shown in FIG. 9.

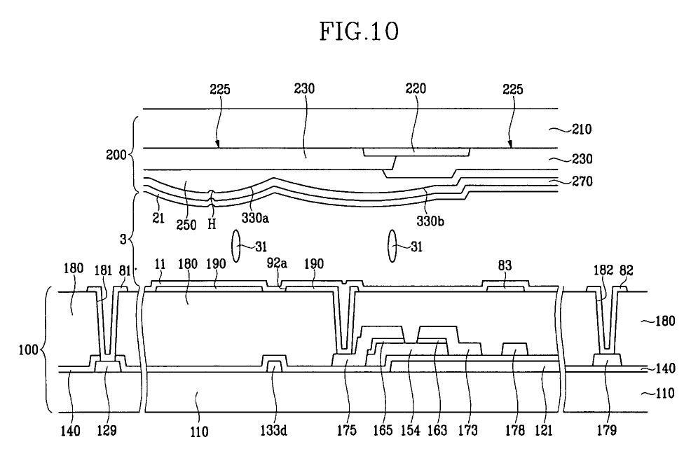

A liquid crystal display according to another exemplary embodiment of the present invention will be described in detail with reference to FIG. 10.

FIG. 10 is a cross-sectional view taken along Line IV-IV′-IV″-IV′″ of FIG. 1 as another example of a cross-sectional view of yet another alternative exemplary embodiment of the liquid crystal display shown in FIGS. 1 to 3.

As shown in FIG. 10, the liquid crystal display according to the present exemplary embodiment includes a thin film transistor panel 100 and a common electrode panel 200 opposed to each other, and a liquid crystal layer 3 interposed therebetween.

The layered structures of the panels 100 and 200 according to the present embodiment are similar to those of the liquid crystal display shown in FIGS. 1 to 4.

The layered structure of the thin film transistor panel 100 is described first. A plurality of gate lines 121 having gate electrodes 124 and end portions 129 and a plurality of storage electrode lines 131 having storage electrodes 133a to 133d are formed on a panel 110. A gate insulating layer 140, a plurality of line-shaped semiconductor patterns 151 including extensions 154, and a plurality of line-shaped ohmic contact members 161 having extensions 163 and a plurality of island-shaped ohmic contact members 165 are sequentially formed thereon. A plurality of data lines 171 including source electrodes 173 and end portions 179, a plurality of drain electrodes 175, and a plurality of isolated metal pieces 178 are formed on the ohmic contact members 161 and 165, and a passivation layer 180 is formed thereon. A plurality of contact holes 181, 182, 183a, 183b, and 185 are formed in the passivation layer 180 and the gate insulating layer 140, and a plurality of pixel electrodes 190 having cut portions 91, 92a, and 92b, a plurality of contact assistants 81 and 82, and a plurality of overpasses 83 are formed thereon.

The layered structure of the common electrode panel 200 is now described. A light blocking member 220 having a plurality of openings 225, a common electrode 270, a plurality of color filters 230, a plurality of sloped members 330a and 330b, and an alignment layer 21 are formed on an insulating panel 210.

In the liquid crystal display shown in FIG. 10, unlike the embodiment described with respect to FIGS. 1 to 4, the sloped members 330a and 330b are not separately formed on the common electrode 270, but are formed by processing an overcoat layer 250 on the color filters 230 and under the common electrode 270, as illustrated.

The overcoat layer 250 is a layer serving to protect the color filters 230, to prevent the leakage of pigments from the color filters 230, and to provide a flat plane. The overcoat layer 250 is particularly advantageous for the case that cut portions (not shown) are formed in the common electrode 270 to expose the color filters 230.

Instead of forming the sloped members 330a and 330b integrally with the overcoat layer 250, the sloped members 330a and 330b may be separately formed on the overcoat 250.

It will be recognized by those skilled in the pertinent art that many features of the liquid crystal display shown in FIGS. 1 to 4 can apply to the liquid crystal display shown in FIG. 10.

As described above, in the exemplary embodiments of the present invention, by adding the sloped members to tilt the liquid crystal molecules, it is possible to enhance the response speed of the liquid crystal layer, and thus, to manufacture a liquid crystal display that can display a motion image.

In addition, since the sloped members assist the alignment of the liquid crystal molecules, the cut portions may not be formed in the common electrode. Accordingly, since a process of patterning the common electrode can be omitted, it is possible to prevent damage due to static electricity being introduced during such a process.

Furthermore, by forming the concave portion or the convex portion in the top portions of the sloped members, the liquid crystal molecules, which are not affected by an electric field, can be minimized, thereby preventing collisions between the liquid crystal molecules. Therefore, it is possible to provide a liquid crystal display with a high image quality, which does not generate an afterimage.

While the present invention has been described in detail with reference to the exemplary embodiments, those skilled in the art will appreciate that various modifications and substitutions can be made thereto without departing from the spirit and scope of the present invention as set forth in the appended claims.

What is claimed is:

1. A liquid crystal display comprising:
a panel;
an electric field generating electrode formed on the panel; and
a sloped member formed on the panel and having a ridge and a slope,
wherein at least one singular portion is formed in the ridge.

2. The liquid crystal display of claim 1, wherein the singular portion has a concave shape or convex shape.

3. The liquid crystal display of claim 1, wherein the singular portion is symmetric about the ridge.

4. The liquid crystal display of claim 1, wherein a width of the singular portion extending from the ridge is in the range of about 10 μm to about 15 μm, and a length of the singular portion extending along the ridge is about 20 μm or less.

5. The liquid crystal display of claim 1, wherein the singular portion is disposed at a center of the ridge.

6. The liquid crystal display of claim 1, wherein two or more singular portions are disposed in the ridge.

7. The liquid crystal display of claim 1, wherein a bottom surface or top surface of the singular portion is one of flat and non-planar.

8. The liquid crystal display of claim 1, wherein the electric field generating electrode covers an entire surface of the panel.

9. The liquid crystal display of claim 1, wherein a tilt angle of a slope of the sloped member is in the range of about 1° to about 10°.

10. The liquid crystal display of claim 1, wherein the slope is non-planar.

11. The liquid crystal display of claim 1, wherein the thickness of the sloped member is in the range of about 0.5 μm to about 2.0 μm.

12. The liquid crystal display of claim 1, further comprising a plurality of color filters formed below the electric field generating electrode.

13. The liquid crystal display of claim 12, further comprising an overcoat layer formed between the electric field generating electrode and the color filters.

14. The liquid crystal display of claim 13, wherein the sloped member is disposed between the overcoat layer and the common electrode.

15. The liquid crystal display of claim 14, wherein the sloped member is formed integrally with the overcoat layer.

16. A liquid crystal display comprising:
a panel;
a first electric field generating electrode formed on the panel;
a second electric field generating electrode opposed to the first electric field generating electrode;
a liquid crystal layer interposed between the first electric field generating electrode and the second electric field generating electrode; and
a sloped member formed on the panel and having a ridge and a slope,
wherein at least one singular portion is formed in the ridge.

17. The liquid crystal display of claim 16, wherein the singular portion has a concave shape or convex shape.

18. The liquid crystal display of claim 16, wherein the singular portion is symmetric about the ridge.

19. The liquid crystal display of claim 16, wherein a width of the singular portion extending from the ridge is in a range of about 10 μm to about 15 μm, and a length of the singular portion extending along the ridge is about 20 μm or less.

20. The liquid crystal display of claim 16, wherein a bottom surface or top surface of the singular portion is one of flat and non-planar.

21. The liquid crystal display of claim 16, wherein the electric field generating electrodes cover an entire surface of the panel.

22. The liquid crystal display of claim 16, wherein a tilt angle of a slope of the sloped member is in a range of about 1° to about 10°.

23. The liquid crystal display of claim 16, wherein the sloped member occupies half an area of the electric field generating electrodes.
